(19) United States
(12) Patent Application Publication
(10) Pub. No.: US 2016/0309234 A1
(43) Pub. Date: Oct. 20, 2016

(54) METHOD AND SYSTEM FOR DISPLAYING REBROADCAST WATERMARK

(71) Applicants: LE HOLDINGS (BEIJING) CO., LTD., Beijing (CN); LE SHI INTERNET INFORMATION TECHNOLOGY CORP. BEI JING, Beijing (CN)

(72) Inventors: Yang LI, Beijing (CN); Qing XIA, Beijing (CN); Xianjin CAO, Beijing (CN)

(21) Appl. No.: 15/101,886

(22) PCT Filed: Nov. 25, 2014
(86) PCT No.: PCT/CN2014/092138

§ 371 Date: Jun. 3, 2016

(30) Foreign Application Priority Data
Dec. 4, 2013 (CN) 201310646642.4

(51) Int. Cl. H04N 21/488; H04N 21/81; H04N 21/44; H04N 21/8358

(52) U.S. Cl. CPC H04N 21/4886; H04N 21/8358; H04N 21/8153; H04N 21/44008

(57) ABSTRACT

The embodiments of the disclosure disclose a method and a system for displaying a rolling broadcast watermark. The method comprises: detecting a program having no station logo information in program information played by a rolling broadcast station; looking up and acquiring station logo information of a program station corresponding to the program according to the detected program; performing watermarking process on the station logo information, and when a program of the program station is played, displaying the station logo information having a watermark in a specific area along with the program of the program station. The embodiments of the present disclosure extract corresponding program information and program station information according to contents recorded in program lists of different program stations and performs a watermarking process, thus effectively solving the problem of displaying a rolling broadcast watermark in a rolling broadcast station.

### CROSS-REFERENCE TO RELATED APPLICATIONS

The present disclosure claims the priority of Chinese Patent Application No. 201310646642.4, filed in the Chinese Patent Office on Dec. 4, 2013, and entitled “METHOD AND SYSTEM FOR DISPLAYING ROLLING BROADCAST WATERMARK”, the entire contents of which are incorporated herein by reference.

### FIELD OF TECHNOLOGY

The embodiments of present disclosure relate to the field of Internet television play interfaces, and in particular to a method and a system for displaying a rolling broadcast watermark.

### BACKGROUND

In the prior art, Internet television, as an emerging technology integrating the technologies of Internet, multimedia, communication and the like, combines the Internet technology with the television technology, and provides all-round media services for all the terminal users connected to the broadband. The Internet television, combining strong network functions with television clients, not only reserves the visual, intuitive, vivid and flexible characteristics of television, but also has the interactive feature of on-demand acquisition of Internet in the process of integrating two media including television and network, and therefore is a new propagation form synthesizing the advantages of the two media. Thus, users not only can watch programs of program stations, but also can find various desired programs in rich network resources through the Internet function.

At present, a service end of Internet television is provided with multiple different play servers for providing various media services such as video-on-demand, live play, rolling broadcast and the like for a user. In order to improve the user experience, rich video contents such as variety show, news, movies and television plays, songs and the like in the play servers are generally played in different “program stations (or program channels)”, such as a movie station, a news station, a music station and the like; or the service types of different video contents in the play servers are played in different “program stations”, such as a live play station, a rolling broadcast station and the like. Then, the user changes different “program stations” by switching to watch different video programs, thus reserving the traditional television watching habit. When video programs are played, each “program station” has different station logo watermarks, and the user can learn the current channel through the station logo watermark; moreover, the video programs played by different “program stations” display corresponding program information in a mode of different program watermarks, so that the user can learn the current played video program information in time.

However, when video programs are played in the rolling broadcast station, different hot video programs are screened from other “program stations” and played, so that the contents of the video programs are incoherent and jumpy, and the screened video programs of the rolling broadcast station cannot generate corresponding program watermarks and current program information in time. Accordingly, when the user watches a video program in the rolling broadcast station, he cannot learn relevant information of the program.

### SUMMARY

In view of this, the embodiments of the disclosure provide a method and a system for displaying a rolling broadcast watermark, thus solving the technical problem of displaying a rolling broadcast watermark in a rolling broadcast station.

In order to solve the above technical problem, the embodiments of the disclosure disclose a method for displaying a rolling broadcast watermark, including:

detecting a program having no station logo information in program information played by a rolling broadcast station;

looking up and acquiring station logo information of a program station corresponding to the program according to the detected program;

performing watermarking process on the station logo information, and displaying the station logo information having a watermark in a specific area along with the program of the program station, when a program of the program station is played.

Additionally or alternatively, the station logo information is specifically:

formed by any combination of program station type information, program station identification information and/or program information.

Additionally or alternatively, the processing of displaying the station logo information having a watermark in a specific area along with the program of the program station when a program of the program station is played, including:

displaying the station logo information having a watermark and formed by any combination of program station type information, program station identification information and/or program information in a specific area along with the program of the program station in a scroll mode, when a program of the program station is played.

Additionally or alternatively, the processing of looking up and acquiring station logo information of a program station corresponding to the program according to the detected program is specifically:

looking up different program station addresses corresponding to different programs according to the detected program, and acquiring corresponding station logo information according to the program station address;

wherein, the program station address includes a play address or a domain name.

Additionally or alternatively, the processing of watermarking is specifically:

performing a transparency processing on the color of the station logo information.

In order to solve the above technical problem, the embodiments of the present disclosure further disclose a system for displaying a rolling broadcast watermark, including: a detection unit, a lookup unit and a display processing unit, wherein,

the detection unit is configured to detect a program having no station logo information in program information played by a rolling broadcast station;

the lookup unit is configured to look up and acquiring station logo information of a program station corresponding to the program according to the detected program; and

the display processing unit is configured to watermark the station logo information, and display the station logo information having a watermark in a specific area along with the program of the program station, when a program of the program station is played.

Additionally or alternatively, the station logo information is specifically:

formed by any combination of program station type information, program station identification information and/or program information.

Additionally or alternatively, the display processing unit is specifically configured to:

display the station logo information having a watermark and formed by any combination of program station type information, program station identification information and/or program information in a specific area along with the program of the program station in a scroll mode, when a program of the program station is played.

Additionally or alternatively, the lookup unit is specifically configured to:

look up different program station addresses corresponding to different programs according to the detected program, and acquire corresponding station logo information according to the program station address;

wherein, the program station address includes a play address or a domain name.

Additionally or alternatively, the display processing unit is specifically configured to:

perform a transparency processing on the color of the station logo information.

Compared with the prior art, the method and the system for displaying a rolling broadcast watermark in the embodiments of the present disclosure achieve the following effects:
1) Corresponding program information and program station information are extracted according to contents recorded in program lists of different program stations and watermarked, so that the problem of displaying a rolling broadcast watermark in a rolling broadcast station is effectively solved.
2) Multiple kinds of information such as program information, program station information, play theatres and the like in a rolling broadcast station are alternatively displayed in a constant watermark area, so that the area occupied by the watermark in a display area of a play interface is greatly reduced, and the user experience is improved; moreover, the display position of the watermark area and the display time of different program information in the watermark can be adjusted according to user's operation, so that interactive experience is enhanced.

Of course, any product implementing the embodiments of the present disclosure does not need to simultaneously achieve all of the above technical effects.

### BRIEF DESCRIPTION OF THE DRAWINGS

The accompanying drawings described herein are used for providing specific understanding of the embodiments of the present disclosure and constituting a part of the embodiments of the present disclosure, and exemplary embodiments and descriptions thereof of the present disclosure are used for interpreting the present disclosure, rather than improperly limiting the present disclosure. In the figures:

FIG. 1 shows a flow block diagram of a method for displaying a rolling broadcast watermark in embodiment 1 of the present disclosure;

FIG. 2 shows a flow block diagram of a method for displaying a rolling broadcast watermark in embodiment 2 of the present disclosure;

FIG. 3 shows a specific schematic diagram of a watermark of station logo information in a method for displaying a rolling broadcast watermark in embodiment 3 of the present disclosure;

FIG. 4 shows a specific schematic diagram of a rolling broadcast station logo watermark in the method for displaying a rolling broadcast watermark in embodiment 3 of the present disclosure;

FIG. 5 shows a structural block diagram of a system for displaying a rolling broadcast watermark in embodiment 4 of the present disclosure.

### DESCRIPTION OF THE EMBODIMENTS

Some words are used in the specification and the claims to indicate specific components. Those skilled in the art should understand that a hardware manufacturer may call the same component with different nouns. The specification and the claims do not distinguish the components with the difference of names, but take the functional difference of the components as the distinguishing criteria. For example, “include” mentioned in the specification and the claims is an open term, and should be understood as “include but are not limited to”. “Roughly” indicates an acceptable error range in which those skilled in the art could solve the technical problems and basically achieve the technical effects. Moreover, “coupling” herein includes any direct and indirect electrical coupling means. Thus, if a first device is coupled to a second device as mentioned in the context, the first device can be directly electrically coupled to the second device, or indirectly electrically coupled to the second device through other devices or coupling means. Described below in the specification are preferred embodiments of the present disclosure, which are used for describing common principles of the embodiments of the present disclosure, rather than limiting the scope of the present invention. The protection scope of the appended claims should prevail over the protection scope of the present disclosure.

### Embodiment 1

FIG. 1 shows a method for displaying a rolling broadcast watermark in embodiment 1 of the present disclosure. The method includes the following steps.

Step 101, a program having no station logo information in program information played by a rolling broadcast station is detected.

Wherein, the station logo information specifically may be formed by any combination of program station type information, program station identification information and/or program information. Of course, the station logo information may also be formed and displayed in other mode, and the embodiments of the present disclosure are not limited thereto.

It should be noted that, the service end of an Internet television is provided with a plurality of different program stations for playing video programs with rich contents, meanwhile, the Internet television can play programs in traditional cable television stations or digital television stations. Particularly, the rolling broadcast station also has a corresponding service end (e.g., a rolling broadcast server), which is configured to screen programs in each program station, so that hot video programs in different program stations or television stations can be uninterruptedly played, and a user can watch different rich video programs such as movies and television plays, music, variety show or news and the like in the same channel. However, for the program stations of a non-Internet television service end (e.g., local television stations, digital television stations, network stations and the like in each district), the played programs always have watermark logos corresponding to different station logo information (e.g., some programs have logo pattern watermarks of different program stations, while some programs only have watermarks of program names), which do not conform to uniform watermark logos of program stations in the current Internet television, so that when the programs are screened in the service end of the rolling broadcast station, the watermark logos corresponding to the station logo information in the programs may be filtered. Thus, when the programs are played in the rolling broadcast station, it needs to detect a program having no station logo information in program information corresponding to the programs played by the rolling broadcast station.

Step 102, station logo information of a program station corresponding to the program is looked up and acquired according to the detected program.

Different programs are transmitted in a mode of data stream during playing, the data stream corresponding to a program includes corresponding program information including name, resolution and code stream magnitude of the program as well as name and play address of the corresponding program station (the play address of a network station is the domain name of the service end corresponding to the network station), and with regard to a program having no station logo information, a corresponding program station needs to be looked up on the basis of the name or play address information of the corresponding program station in the program information, and then the station logo information of the corresponding program is queried through the corresponding query port in the program station.

Step 103, the station logo information is watermarked, and when a program of the program station is played, the station logo information having a watermark is displayed in a specific area along with the program of the program station.

Regarding step 103, the watermark of the station logo information may be displayed in multiple modes, and the scope or position of the specific area for displaying the watermark may also be displayed in multiple modes. The watermark and the specific area for watermark display can be set by a corresponding service end of the rolling broadcast station or set by a user. Of course, the watermark of the station logo information and the specific area for displaying the watermark can be adjusted in other mode, but the embodiments of the present disclosure are not limited thereto.

### Embodiment 2

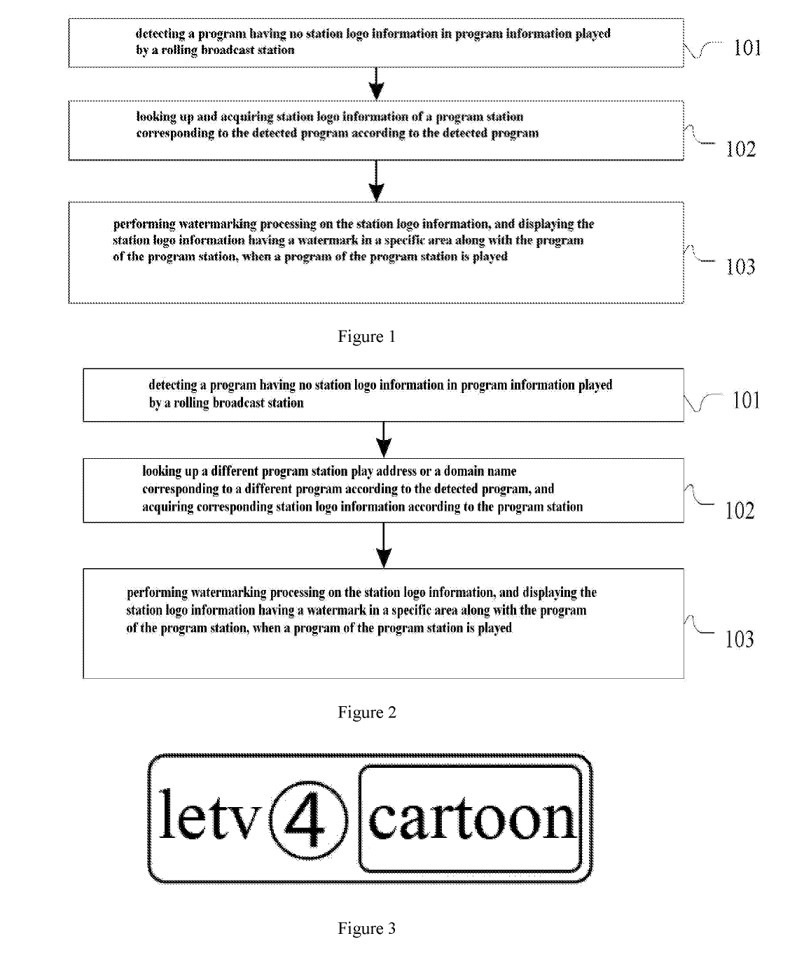

FIG. 2 shows a method for displaying a rolling broadcast watermark in embodiment 2 of the present disclosure. The method includes the following steps.

Step 201, a program having no station logo information in program information played by a rolling broadcast station is detected.

In step 201, the station logo information specifically may be formed by any combination of program station type information, program station identification information and/or program information.

Specifically, when a program played in the rolling broadcast station is detected, a play thread corresponding to the rolling broadcast station is detected, wherein the play thread may be the one at the bottom layer of an Internet television system, and the play thread converts data stream (a transmission form of video, formed in the transmission process) transmitted from the service end of the rolling broadcast station through a corresponding play interface into a video program for playing. Different video programs have corresponding program information (the program information is generated during transcoding of the video programs), and corresponding program information can be extracted by detecting the data stream transmitted in the play interface of the play thread, so that the program having no station logo information in the program information can be specifically detected.

Step 202, different program station addresses corresponding to different programs are looked up according to the detected program, and corresponding station logo information is acquired according to the program station address. Wherein, the program station address specifically includes a play address or a domain name.

Step 202 is specifically: URLs (Uniform Resource Locators) of different program stations corresponding to different programs are looked up according to the detected program, and corresponding station logo information is downloaded according to the URL of the program station.

Different program stations are set in different servers (the program stations of the service end of Internet television may be set in the same server, which is not limited herein), then the address of the corresponding program station or the domain name of the server thereof can be extracted from the program information corresponding to the program, namely, URL, and the station logo information of the corresponding program is acquired through a corresponding query port in the program station.

It should be noted that, each program station has a unique URL, and accurate access and query can be performed after the URL is found.

Step 203, the station logo information is watermarked, and when a program of the program station is played, the station logo information having a watermark is displayed in a specific area along with the program of the program station.

Wherein, in step 203, after the station logo information is watermarked, it specifically can be bound with the corresponding program, of course, it can also adopt a code embedding mode or the like, and the embodiments of the present disclosure are not limited thereto.

Step 203 is specifically: when a program of the program station is played, the station logo information having a watermark and formed by any combination of program station type information, program station identification information and/or program information is displayed in a specific area along with the program of the program station in a scroll mode.

More specifically, the watermark of the station logo information may be displayed in multiple modes, e.g., a scroll bar mode, that is, the watermark of the station logo information is displayed in a scroll bar mode at the upper or lower part of a screen or at a position not influencing the watching experience of a user. Of course, in order to better improve the watching experience of the user, intermittent display may also be adopted, that is, after the watermark of the station logo information is displayed for a period of time, the watermark is concealed. Wherein, the display modes of the watermarks of different station logo information may be set by a user, e.g., customizing the position of a scroll bar, customizing the time interval of intermittent display and the like.

Meanwhile, the range or position of the specific area for displaying the watermark may also be displayed in multiple modes, e.g., the specific area is set to be oblong, square or other geometrical figure, and then the watermark of the station logo information can only be displayed in the specific area in an oblong or square mode.

It should be noted that, after the watermark of the station logo information is generated, the watermark including program station type information, program station identification information and/or program information in the station logo information is dynamically displayed, wherein the dynamic display specifically may be scroll display, gradient alternate display, turnover display and/or other display mode with a dynamic display effect.

In addition, step 203 of performing watermarking process on the station logo information specifically includes: embedding the station logo information into data stream formed by the program in a code form, adjusting the color transparency of the station logo information, and then binding the station logo information with the corresponding program.

### Embodiment 3

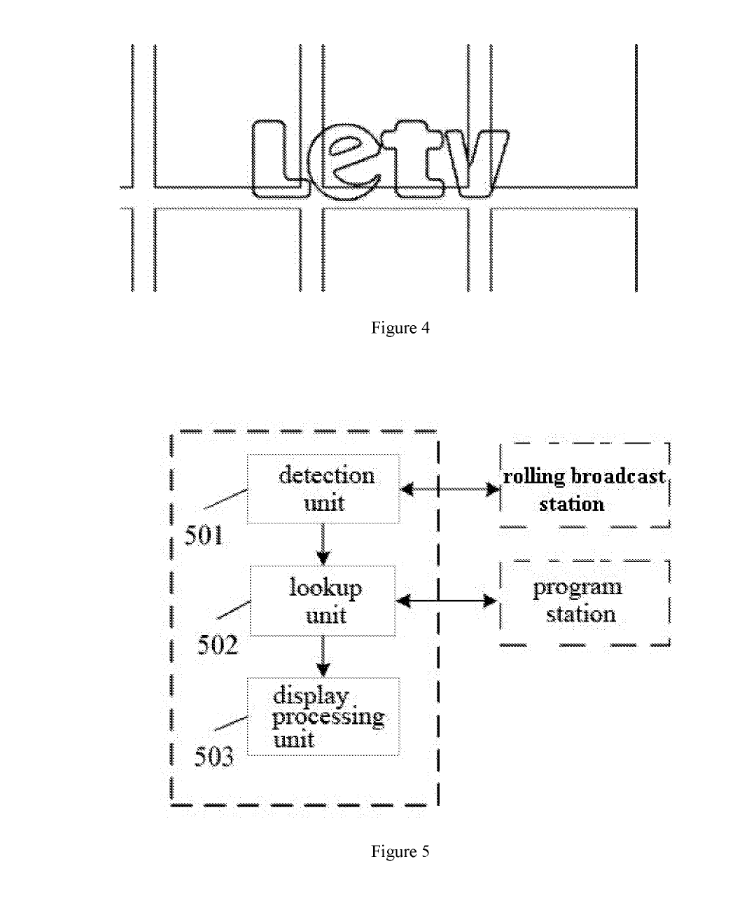

A specific embodiment of disclosure of the method for displaying a rolling broadcast watermark will be described in detail below in combination with FIG. 3 and FIG. 4.

Setting: taking 18:00 to 20:00 as an example, the rolling broadcast station of letv plays a cartoon “Episode 203 of Detective Conan” in cartoon channel 4 (domain name: http://comic4.com) at 18:00 for 40 minutes; the rolling broadcast station plays a movie “Kung Fu Panda” relayed by a certain network station A (play address: http://moviel.com) at 18:40 for 1 hour and 20 minutes.

This process is as follows:

Step 301, program information corresponding to the cartoon played by the rolling broadcast station is detected at 18:00; program information corresponding to the movie played by the rolling broadcast station is detected at 18:40, and both the cartoon and the movie do not have station logo information by detecting.

Step 302, the domain name http://comic4.com of the cartoon station and the play address http://moviel.com of the network station A corresponding to the cartoon and the movie are separately looked up according to the detected cartoon and movie, station logo information of the cartoon is acquired according to the domain name, and station logo information of the movie is acquired according to the play address.

Step 303, the station logo information of the cartoon and the station logo information of the movie are respectively watermarked and correspondingly bound: when the cartoon is played, the station logo information of the cartoon having a watermark is displayed in a specific area along with the cartoon; and when the movie is played, the station logo information of the movie having a watermark is displayed in a specific area along with the movie.

Specifically:

At 18:00 to 18:40, a user watches the rolling broadcast station which is playing a cartoon “Episode 203 of Detective Conan” in letv cartoon channel 4, the name of the program and the URL of the channel, namely http://comic4.com, can be acquired by detecting the program information of the cartoon, a corresponding query interface is found by accessing the URL, the program name “Episode 203 of Detective Conan” of the carbon is input, then such time length information as start time, end time and the like of the carbon can be queried, meanwhile, such station logo information as channel name “letv cartoon channel 4”, station logo figure and the like can also be queried, and the user can see the watermark of the corresponding station logo information after watermarking as shown in FIG. 3. As shown in FIG. 3, the watermark of “letv cartoon channel 4” and “Episode 203 of Detective Conan” can be displayed in multiple modes such as scroll display, gradient alternate display, turnover display or the like (FIG. 3 does not show the display mode of “Episode 203 of Detective Conan”).

At 18:40, after the “Episode 203 of Detective Conan” is ended, the program information of the movie “Kung Fu Panda” is immediately detected to acquire the name of the movie “Kung Fu Panda” and the URL of the channel, namely, http://moviel.com, a corresponding query interface is found by accessing the URL, the program name “Kung Fu Panda” of the movie is input, then such time length information as start time, end time and the like of the movie can be queried, meanwhile, such station logo information as channel name “network station A”, station logo figure and the like can also be queried, and the user can see the watermark of the corresponding station logo information after watermarking. At the moment, the watermark shown in FIG. 3 is changed (not shown in the figure) into a watermark of “network station A” and “Kung Fu Panda”, which is displayed in multiple modes such as scroll display, gradient alternate display, turnover display or the like.

In addition, the watermark of the station logo information of the rolling broadcast station is displayed as shown in FIG. 4, and the watermark may be intermittently displayed, that is, after the watermark of the station logo information is displayed for a period of time, the watermark is concealed. When the rolling broadcast station plays any program, the watermark “letv” is displayed and automatically concealed after a period of time (e.g., 10 seconds).

It should be noted that, the display range, position, intermittent display time interval and the like of the watermark can be set by a user in this embodiment.

### Embodiment 4

FIG. 5 shows a system for displaying a rolling broadcast watermark in embodiment 4 of the present disclosure, which is coupled with a rolling broadcast station and a plurality of program stations. The system includes a detection unit 501, a lookup unit 502 and a display processing unit 503.

The detection unit 501 is coupled with the rolling broadcast station and the lookup unit 502, and is configured to detect a program having no station logo information in program information played by the rolling broadcast station.

The lookup unit 502 is coupled with the plurality of program stations, the detection unit 501 and the display processing unit 503, and is configured to look up and acquire station logo information of a program station corresponding to the program according to the detected program.

The display processing unit 503 is coupled with the lookup unit 502, and is configured to watermark the station logo information, and display the station logo information having a watermark in a specific area along with the program of the program station, when a program of the program station is played.

When the detection unit 501 detects the program played in the rolling broadcast station, a play thread corresponding to the rolling broadcast station is detected, wherein the play thread may be the one at the bottom layer of an Internet television system, and the play thread converts data stream transmitted from the service end of the rolling broadcast station through a corresponding play interface into a video program for playing. The detection unit 501 can extract corresponding program information by detecting the data stream transmitted in the play interface of the play thread, thus specifically detecting the program having no station logo information in the program information.

Wherein, the station logo information specifically may be formed by any combination of program station type information, program station identification information and/or program information.

The lookup unit 502 is specifically configured to look up different program station addresses corresponding to different programs according to the detected program, and acquire corresponding station logo information according to the program station address. Wherein, the program station address includes a play address or a domain name, which may be URL.

It should be noted that, different program stations are set in different servers, then the lookup unit 502 can extract the address of the corresponding program station or the domain name of the server thereof from the program information corresponding to the program, namely, URL, to find the corresponding program station, and acquire the station logo information of the corresponding program through a corresponding query port in the program station.

The display processing unit 503 is specifically configured to: display the station logo information having a watermark and formed by any combination of program station type information, program station identification information and/or program information in a specific area along with the program of the program station in a scroll mode, when a program of the program station is played.

Meanwhile, the display processing unit 503 is also specifically configured to: embed the station logo information into data stream formed by the program in a code form, adjust the color transparency of the station logo information, and then bind the station logo information with the corresponding program.

The embodiments of the present disclosure further provide a system for displaying a rolling broadcast watermark, comprising: one or more processors; a memory; and one or more modules stored in the memory, the one or more modules are configured to perform the following operations when being executed by the one or more processors: detecting a program having no station logo information in program information played by a rolling broadcast station; looking up and acquiring station logo information of a program station corresponding to the program according to the detected program; and performing watermark processing on the station logo information, and display the station logo information having a watermark in a specific area along with the program of the program station when a program of the program station is played.

Additionally or alternatively, the station logo information is further: formed by any combination of program station type information, program station identification information and/or program information.

Additionally or alternatively, the processor is further configured to perform the following steps: displaying the station logo information having a watermark and formed by any combination of program station type information, program station identification information and/or program information in a specific area along with the program of the program station in a scroll mode, when a program of the program station is played.

Additionally or alternatively, the processor is further configured to perform the following steps: looking up different program station addresses corresponding to different programs according to the detected program, and acquiring corresponding station logo information according to the program station address; wherein, the program station address comprises a play address or a domain name.

Additionally or alternatively, the processor is further configured to perform the following steps: performing a transparency processing on the color of the station logo information.

Since this embodiment of the present disclosure has been described in detail in the method portions, the detailed descriptions of the portions, corresponding to the methods, of the system in this embodiment are omitted herein. For the descriptions of the specific contents in the system, reference may be made to the contents of the method embodiments, which will not be specifically limited herein.

Compared with the prior art, the method and the system for displaying a rolling broadcast watermark in the embodiments of the present disclosure achieve the following effects:
1) Corresponding program information and program station information are extracted according to contents recorded in program lists of different program stations and watermarked, so that the problem of displaying a rolling broadcast watermark in a rolling broadcast station is effectively solved.
2) Multiple kinds of information such as program information, program station information, play theatres and the like in a rolling broadcast station are alternatively displayed in a constant watermark area, so that the area occupied by the watermark in a display area of a play interface is greatly reduced, and the user experience is improved; moreover, the display position of the watermark area and the display time of different program information in the watermark can be adjusted according to user's operation, so that interactive experience is enhanced.

It should be further noted that, terms “comprise”, “include” or any other variants thereof intend to cover non-exclusive inclusion, so that a process, a method, a commodity or a system including a series of factors not only includes these factors, but also includes other factors not definitely listed, or includes inherent factors of the process, method, commodity or system. In the absence of more restrictions, the factor defined by the statement “including one . . . ” does not exclude other same factor in the process, method, commodity or system including the factor.

It should be appreciated by those skilled in the art that the embodiments of the present disclosure may be provided as methods, systems or computer program products. Therefore, the embodiments of the present disclosure may adopt the form of complete hardware embodiments, complete software embodiments or embodiments of software and hardware in combination. Moreover, the embodiments of the present disclosure may adopt the form of computer program products implemented on one or more computer-useable storage media (including but not limited to a magnetic disk memory, a compact disc read-only memory (CD-ROM), an optical memory and the like) including computer-usable program codes.

The foregoing descriptions are merely specific implementations of the present invention, but the protection scope of the present invention is not limited hereto. Any skilled one who is familiar with this art could readily think of variations or substitutions within the disclosed technical scope of the present invention, and these variations or substitutions shall fall within the protection scope of the present invention. Accordingly, the protection scope of the claims should prevail over the protection scope of the present invention.

1. A method for displaying a rolling broadcast watermark, comprising:
detecting a program having no station logo information in program information played by a rolling broadcast station;
looking up and acquiring station logo information of a program station corresponding to the detected program according to the detected program;
performing watermarking processing on the station logo information, and displaying the station logo information having a watermark in a specific area along with the program of the program station, when a program of the program station is played.

2. The method for displaying a rolling broadcast watermark of claim 1, wherein the station logo information is further:
formed by any combination of program station type information, program station identification information and/or program information.

3. The method for displaying a rolling broadcast watermark of claim 2, wherein the processing of displaying the station logo information having a watermark in a specific area along with the program of the program station, when a program of the program station is played, is further as follows:
displaying the station logo information having a watermark and formed by any combination of the program station type information, the program station identification information and/or the program information in scroll in a specific area along with the program of the program station, when a program of the program station is played.

4. The method for displaying a rolling broadcast watermark of claim 1, wherein the processing of looking up and acquiring station logo information of a program station corresponding to the program according to the detected program is further as follows:
looking up a different program station address corresponding to a different program according to the detected program, and acquiring corresponding station logo information according to the program station address;
wherein the program station address comprises a play address or a domain name.

5. The method for displaying a rolling broadcast watermark of claim 1, wherein the processing of watermarking is further as follows:
performing a transparency processing on the color of the station logo information.

6. A system for displaying a rolling broadcast watermark, comprising:
one or more processors;
a memory; and
one or more modules stored in the memory, wherein the one or more modules are configured to perform the following operations when being executed by the one or more processors:
detecting a program having no station logo information in program information played by a rolling broadcast station;
looking up and acquiring station logo information of a program station corresponding to the program according to the detected program; and
performing watermark processing on the station logo information, and displaying the station logo information having a watermark in a specific area along with the program of the program station when a program of the program station is played.

7. The system for displaying a rolling broadcast watermark of claim 6, wherein the station logo information is further:
formed by any combination of program station type information, program station identification information and/or program information.

8. The system for displaying a rolling broadcast watermark of claim 7, wherein the one or more processors are configured to perform the following step:
displaying the station logo information having a watermark and formed by any combination of program station type information, program station identification information and/or program information in a specific area along with the program of the program station in a scroll mode, when a program of the program station is played.

9. The system for displaying a rolling broadcast watermark of claim 6, wherein the one or more processors are configured to perform the following steps:
looking up different program station addresses corresponding to different programs according to the detected program, and acquiring corresponding station logo information according to the program station address,
wherein the program station address comprises a play address or a domain name.

10. The system for displaying a rolling broadcast watermark of claim 6, wherein the one or more processors are configured to perform the following step:
performing a transparency processing on the color of the station logo information.
